(19) United States
(12) Patent Application Publication
(10) Pub. No.: US 2021/0053388 A1
(43) Pub. Date: Feb. 25, 2021

(54) Watercolor Blend

(71) Applicant: Rebecca TONKOVICH, San Leon, TX (US)

(72) Inventor: Rebecca TONKOVICH, San Leon, TX (US)

(21) Appl. No.: 16/998,656

(22) Filed: Aug. 20, 2020

Related U.S. Application Data
(60) Provisional application No. 62/889,938, filed on Aug. 21, 2019.

(51) Int. Cl. B44D 3/02; B44D 3/06; B44D 3/22

(52) U.S. Cl. CPC B44D 3/02; B44D 3/22; B44D 3/06

(57) ABSTRACT

A system for watercolor painting, said system comprising a pallet of watercolor paint, wherein said pallet comprises a first watercolor paint and a second watercolor paint, and wherein the first and second watercolor paints comprise a dissimilar color; wherein the first water paint is adjacent, above, and parallel to the second water paint; wherein said pallet comprises a moisture content less than 20%.

### PRIORITY

The present invention claims priority to Provisional Application No. 62/889,938 filed Aug. 21, 2019, the entirety of which is hereby incorporated by reference

### BACKGROUND OF THE INVENTION

### Technical Field

The present invention relates to a system and method for watercolor painting.

### Description of Related Art

Artists uses a variety of paints as well as a variety of mediums to express themselves. One method of painting which has been used throughout the ages is watercolor painting. Watercolor painting allows for a variety of colors to be applied to a surface. The paint hardens when the paint dries. Given the number of painters utilizing watercolor painting, there is a need for new and interesting methods of using watercolor paints.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a top view of a watercolor pallet in one embodiment.

FIG. 2 is a perspective view of a watercolor pallet in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

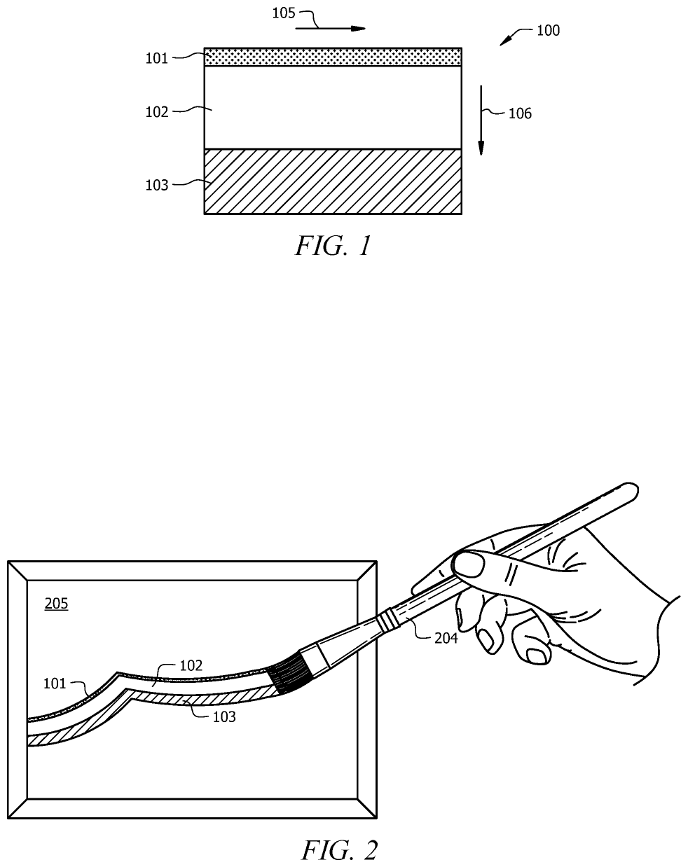

FIG. 1 is a top view of a watercolor pallet in one embodiment. The pallet 100 can come in all shapes and sizes. As depicted, the pallet is a rectangle, but that shape is not limited. In other embodiments the pallet 100 can be square, circular, polygonal, etc. The pallet 100 can comprise virtually any depth.

As shown the pallet comprises three colors: a top color 101, a middle color 102, and a bottom color 103. While three colors are shown, this is for illustrative purposes and should not be deemed limiting. In other embodiments only two colors are used, whereas in still other embodiments, two or more colors are used. In one embodiment at least two colors are dissimilar. In one embodiment at least two colors are the same. For example, in one embodiment the top color 101 and the bottom color 103 comprise the same color. In one embodiment 5, 6, 7, or more than 7 colors are used.

As depicted the top color 101 is above and adjacent to the middle color 102. As depicted, the top color 101 is oriented parallel to the middle color 102. Further, as depicted, the top color 101, for example, has a uniform width throughout the pallet 100 as you move in the horizontal direction 105. Likewise, the middle color 102 has a uniform width throughout the pallet 100 as you move in the horizontal direction 105. However, as can be seen, the top 101 and the middle color 102 comprise uniform but dissimilar widths. Thus, the middle color 102 has a width which is different than the width of the top color 101. However, this is for illustrative purposes and should not be deemed limiting.

In one embodiment the pallet 100 comprises watercolor paint. As used herein, a watercolor paint is a type of paint which typically comprises a dry powder which must be moistened with a suspension, such as water, such that the paints are suspended in a water soluble vehicle. Watercolor paints, in one embodiment, use capillary action to hold onto the bristles of the paintbrush. Thereafter, when the bristles of the paintbrush touch a surface, the paint is released onto the surface.

In one embodiment the watercolor paint comprises pigments, gum arabic, additives such as glycerin, and a solvent such as water. The gum arabic acts as a binder to hold the pigment in suspension and fixes the pigment to the painting surface. Thus, the gum Arabic allows the paint to harden once it is applied to paper. In one embodiment is system paint comprises gum Arabic, no talc, and no lower grade pigments. The additive, in one embodiment, can comprise any additive known in the art, including but not limited to, glycerin, ox gall, honey, preservatives, etc. The additives can be added for a variety of reasons including altering the viscosity, durability, tackiness, and other qualities of the watercolor paint.

In one embodiment, the pigment provides the watercolor's color. The pigment can comprise natural or synthetic pigments. The pigment, in one embodiment, can comprise minerals, organic, and inorganic materials. Virtually any color can be obtained and utilized in the pallet 100.

The solvent is the substance used to thin or dilute the paint for application. In one embodiment the solvent evaporates or partially evaporates when the paint hardens or dries. The solvent can comprise virtually any solvent known in the art, but in one embodiment, the solvent comprises water.

In one embodiment the dry pallet comprises solvent, whereas in another embodiment, the dry pallet does not comprise a solvent. A dry pallet, as used herein, refers to a pallet which comprises a moisture content of less than 10%. A user adds a solvent, such as water, to a dry pallet to convert the dry pallet to a wet pallet. A wet pallet comprises a moisture content greater than 20%.

As those skilled in the art will understand, to use a watercolor paint the dry paint must first be wetted. The pallet 10 can be wetted by dipping, for example, a wet paint brush into the dry pallet. The added solvent allows the dry paint to be collected onto the paint brush for subsequent placement on a painting surface.

FIG. 2 is a perspective view of a watercolor painting in one embodiment. The surface 205 can be any surface suitable for watercolor painting and includes, but is not limited to, water, canvas, cardboard, cardstock, and any other surface typically used for water color painting.

As shown in FIG. 2, a user is holding a brush 204. Virtually any type of brush can be utilized in the method disclosed herein. The brushes can range in thickness from X to Y, and include fine tipped to broad tipped brushes.

As shown in FIG. 2, the user moves the brush 204 across the surface 205. In doing so, as depicted, three separate colors 101, 102, 103 are applied with a single brush stroke. As can be seen the stroke, as depicted, comprises the top color 101, the middle color 101, and the bottom color 103. If the brush were flipped 180° along a horizontal axis, then the top color 101 would be located on the bottom, the middle color 102 would still be in the middle, and the bottom color 103 would be on the top.

As can be seen, a single stroke allows the application of two or more dissimilar colors. This is an unexpected benefit which has several unexpected consequences. First, the ability to apply three colors at once reduces the number of brush strokes and thus saves the user time. Previously, applying the stroke displayed in FIG. 2 would have required three separate strokes. However, using the pallet 100 of FIG. 1 allows three separate colors to be applied with a single stroke. This increases the speed and efficiency of the painting process. Second, because two or more colors are applied with a single stroke, the consistency of application is increased. Turning back to FIG. 2, if all three colors were to be applied individually, the shape of the top color 101 would have to be expertly recreated and mimicked in the middle color 102 and the bottom color 103. Further, the thickness of each color would be controlled by the user. This is often difficult. However, by using the pallet of FIG. 1, the shape and thickness of each color is controlled throughout the length of the stroke.

Third, the selection of the colors can create a seemingly complex and layered effect with a single brush stroke. For example, in one embodiment the pallet of FIG. 1 will comprise colors to resemble a fire. The top color 101 comprises a thin layer of blue, the middle color 102 comprises a thick band of orange, and the bottom color 103 comprises a band of red. When applied to the surface 205, the result is that of a flame. Thus, a complicated and complex color scheme can be created in a simple stroke by selecting colors in a pallet 100.

While a color scheme for a fire has been discussed, this is for illustrative purposes only and should not be deemed limiting.

Returning back to FIG. 1, one method of watercolor painting will now be described. As shown, the pallet 100 comprises three colors stacked vertically in the vertical direction 106. The horizontal direction 105 is the direction running perpendicular to the vertical direction 106.

In one embodiment the pallet 100 begins as a dry pallet. Thereafter, the pallet 100 is wetted to become a wet pallet. The pallet 100 can be wetted by introducing a solvent to the dry pallet. In one embodiment the solvent is poured into the pallet 100. In another embodiment the solvent is applied to the pallet 100 via a moist brush. In one embodiment sufficient solvent is added to make the watercolor paint adhere to the brush, but not so much solvent that the colors begin to run. In this fashion, the distinct lines between adjacent colors is preserved. This is an unexpected result. Typically, watercolor paints are stored in separate deposits. In other words, the blue watercolor paint was separated from the yellow watercolor paint for fear the colors would mix and become green. Thus, the industry standard and practice is to separate watercolor paints. As such, the prior art teaches away from a pallet 100 which comprises two or more adjacent colors in a single container.

Next, the user swipes the brush 204 across the pallet 100. In one embodiment the user swipes the brush 204 in the horizontal direction. Swiping the brush 204 in the horizontal direction when the pallet 100 is arranged with the colors stacked vertically as shown in FIG. 1, allows the same cross-section of colors depicted in the pallet 100 to be adhered to the brush 204. In one embodiment the brush 204 is swiped two or more times in the horizontal direction in a back and forth movement. Thus, for example, a user will swipe from left to right, then right to left, etc. Such a swiping method allows watercolor paint to adhere to both sides of the brush 204. This allows the user to utilize both sides of the brush 204 in painting.

In other embodiments the user can swipe in the vertical direction 106, either up or down. Such a swipe allows the user to get a combination of colors mixed on the brush 204.

In one embodiment the wetting step and the swiping step occur simultaneously. Thus, the dry pellet is wetted via application of a wet brush.

After adhering paint to the brush 204, the user deposits paint on the surface 205. The user can use any brush stroke techniques known in the art. As noted, in one embodiment two or more colors are deposited simultaneously with a single stroke. In one embodiment the two or more paint colors are deposited such as to mimic the cross-section of the pallet 100. Thus, in one embodiment, if the pallet 100 comprises a top color 101, a middle color 102, and a bottom color 103, the paint stroke will resemble the layout in the pallet 100.

In one embodiment, the user swipes such that the brush 204 contacts each color in the pallet 100. In other embodiments, however, the user only selects only one or more colors and limits the swiping of the brush 204 to the desired paint. Thus, for example, if user swipes the brush 204 so that it only contacts the top color 102 and the middle color 103, then the resulting brush stroke on the surface will only show the two colors. This flexibility gives the user the opportunity to selectively choose the desired color scheme.

As discussed above, the disclosed method has many unexpected benefits including increased efficiency, increased consistency, and reducing the number of strokes.

Another benefit is that the color combinations are limitless. Virtually any color can be used in the pallet 100 to obtain a multitude of color combinations. The system and method allow the artist to blend, highlight and shadow with a single stroke.

While the invention has been particularly shown and described with reference to a preferred embodiment, it will be understood by those skilled in the art that various changes in form and detail may be made therein without departing from the spirit and scope of the invention.

What is claimed is:

1. A system for watercolor painting, said system comprising:
a pallet of watercolor paint, wherein said pallet comprises a first watercolor paint and a second watercolor paint, and wherein the first and second watercolor paints comprise a dissimilar color;
wherein the first water paint is adjacent, above, and parallel to the second water paint;
wherein said pallet comprises a moisture content less than 20%;
wherein the watercolor paint comprises gum arabic.

2. The system of claim 1 wherein said pallet comprises three or more colors.

3. The system of claim 1 wherein said pallet comprises a dry pallet.

4. The system of claim 1 wherein said pallet comprises no dividers between said first and second watercolor paints.

5. The system of claim 1 wherein said pallet comprises a divider between said first and second watercolor paints.

6. The system of claim 1 wherein said first and second watercolor paints have uniform width in said pallet.

7. The system of claim 1 wherein said first and second watercolor paints have dissimilar widths.

8. A method of painting with watercolor paints, said method comprising the steps of:
a) obtaining a pallet of watercolor paints, wherein said pallet comprises at least two watercolor paints comprising dissimilar colors, and wherein said pallet comprises a dry pallet, wherein said watercolor paint comprises gum arabic;
b) wetting said dry pallet with a solvent to produce a wet pallet;
c) swiping a brush along said pallet to adhere watercolor paint on said brush;
d) depositing at least some of said watercolor paint on a surface.

9. The method of claim 8 wherein steps b) and c) occur simultaneously.

10. The method of claim 8 wherein said solvent comprises water.

11. The method of claim 8 wherein said at least two watercolor paints are stacked vertically.

12. The method of claim 11 wherein said swiping of step c) comprises swiping in the horizontal direction.

13. The method of claim 8 wherein said depositing step comprises depositing said at least two watercolor paints simultaneously with a single stroke.

13. The method of claim 8 further comprising:
e) rewetting said brush;
f) swiping the brush along the pallet to adhere watercolor paint on the brush;
g) depositing at least some of the watercolor paint on a surface.
